(19) United States
(12) Patent Application Publication
(10) Pub. No.: US 2006/0118324 A1
(43) Pub. Date: Jun. 8, 2006

(54) Separable wire bundle

(76) Inventors: Alan T. Pfeifer, Wichita, KS (US); Raymond S. Rowhuff, Wichita, KS (US)

Correspondence Address: LSI LOGIC CORPORATION, 1621 BARBER LANE, MS: D-106, MILPITAS, CA, 95035, US

(21) Appl. No.: 11/004,166

(22) Filed: Dec. 3, 2004

(51) Int. Cl. H01B 7/08

(52) U.S. Cl. 174/117 F

(57) ABSTRACT

A wire bundle including a plurality of insulated wires forming a bundle having a chosen length, wherein the wires are disposed substantially parallel to one another and are joined together along the chosen length by a connecting material which is capable of being torn without the use of tools, such that the wires can be separated from one another without affecting the insulation thereof along at least a portion of the chosen length is described. Such a wire bundle permits the connection of wires to integrated circuits having small-pitch connection pins to be more readily made. By forming an electrical contact between one wire in the wire bundle and a connector pin of the integrated circuit by soldering, as an example of a connection process, the other wires in the bundle are automatically aligned and stabilized with respect to the other connector pins of the integrated circuit. Soldering of these other connections can then be more readily accomplished.

### FIELD OF THE INVENTION

The present invention relates generally to connecting wires to integrated circuits and, more particularly, to a readily separable wire bundle for electrically connecting wires to integrated circuits.

### BACKGROUND OF THE INVENTION

Integrated circuits components (ICs) are being produced in smaller-sized packages to accommodate demands for miniaturization of products utilizing such components. Development of proof-of-concept, breadboard designs making using these small-pitch ICs has as a result become more difficult, since electrically connecting wires thereto by soldering, as an example, has become increasingly challenging.

Hand soldering wires to the small pitch ICs in bread-board applications often has the undesirable effect of not allowing for clean soldering of individual wires. Moreover, it is difficult to position a wire in place when soldering, and the heating of one wire may undesirably release another wire already in place on the IC. Tape might be used to hold individual wires together while soldering, but this has the disadvantage of making it difficult to properly align individual wires, and tape adhesive may be difficult to remove with the remaining adhesive having poor dielectric properties. Thus, implementing changes in the wiring pattern for small-pitch ICs has become more difficult.

Existing wire bundles, such as those used in multi-pin connectors, as an example, cannot be readily separated. It is undesirable to use a knife or scalpel to separate the wires in the bundle, since it is possible to cut through the wire insulation and into the wires themselves when working with wire bundles having small wire pitches and small wire diameters, perhaps even destroying wire electrical continuity.

Accordingly, it is an object of the present invention to provide an apparatus for more effectively attaching wires to small-pitch integrated circuit components.

Another object of the invention is to provide a method for attaching wires to small-pitch integrated circuits.

Additional objects, advantages and novel features of the invention will be set forth, in part, in the description that follows, and, in part, will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

To achieve the foregoing and other objects of the present invention, and in accordance with its purposes, as embodied and broadly described herein, the separable wire bundle hereof includes: a plurality of spaced-apart neighboring wires forming a bundle having a chosen length, wherein the wires are disposed substantially parallel to one another; a material suitable for providing electrical insulation surrounding each wire; and a connecting material capable of being torn without the use of tools such that each wire is joined to at least one neighboring wire along the chosen length and each wire can be separated from its neighboring wires without affecting the insulation or electrical continuity thereof along at least a portion of the chosen length.

In another aspect of the invention and in accordance with its objects and purposes, the method for connecting wires to the connector pins of an integrated circuit having a pitch, hereof includes the step of electrically connecting one wire from a plurality of spaced-apart neighboring wires forming a wire bundle having a chosen length, wherein the wires are disposed substantially parallel to one another, wherein each wire is surrounded by a material suitable for providing electrical insulation therefor, and wherein each wire is attached to at least one neighboring wire along the chosen length by a connecting material which is capable of being torn without the use of tools, such that each wire can be separated from the at least one neighboring wire without affecting the insulation and electrical continuity thereof along at least a portion of the chosen length, to one connector pin of the integrated circuit, such that the wire bundle is stabilized, and other wires in the wire bundle are aligned with the connector pins of the integrated circuit.

Benefits and advantages of the present invention include, but are not limited to, the ability to access only the number of wires needed to match the pin count of the IC being used; the automatic alignment of the wires with the IC; a reduction in the effort needed to attach each wire using soldering means since the wires in practice are held in place; the wires can be separated after attachment to the IC; and mechanical strength is added to the solder bond by unseparated wire connecting material.

### BRIEF DESCRIPTION OF THE DRAWINGS

The accompanying drawings, which are incorporated in and form a part of the specification, illustrate embodiments of the present invention and, together with the description, serve to explain the principles of the invention. In the drawings:

FIG. 1a is a schematic representation of an end-on view of an embodiment of the wire bundle of the present invention, while FIG. 1b is a schematic representation of a projection view thereof.

FIG. 2a is a schematic representation of a top view of an integrated circuit holder adapted to receive the wire bundle shown schematically in FIG. 1a hereof and an integrated circuit to which at least one of the wires in the bundle of the present invention is to be attached, FIG. 2b is a schematic representation of the front view thereof, and FIG. 2c is a schematic representation of a side view thereof.

### DETAILED DESCRIPTION

Briefly, the present invention includes a plurality of insulated wires having a chosen pitch, where pitch is defined for the purposes hereof as the distance between signal carrying conductors. Pitch may also be defined for the purposes hereof as the distance between pins of an integrated circuit (IC). The plurality of insulated wires are joined together along their length by a connecting material which may be formed from the insulating material surrounding the wires, as an example, or using another material, forming thereby a bundle of wires. The connecting material is adapted to be readily torn such that the wires can be separated from one another without adversely affecting the insulation of the wires, if desired, yet provide sufficient strength to keep the wires together in useful lengths. The wire bundle might be wound on a spool, as an example, from which desired lengths could be cut. In an embodiment of the invention, the wire connecting material is perforated for ease of separation. It is desirable that the wires can be separated without the use of tools without affecting the quality of insulation surrounding the wires. In the situation where the separating material is fabricated from the insulating material, either perforated or non-perforated, the insulating/connecting material is selected to have desired dielectric properties while being readily torn. Extruded polytetrafluoroethylene (PTFE), having a 0.013 (0.33 mm) wall thickness, or a polymer of tetrafluoroethylene and perfluorovinyl ether (PFA), having a 0.013 in. (0.33 mm) wall thickness, are representative examples of suitable insulating/connecting materials.

For the application of soldering wires to ICs, the wire bundle should be substantially planar; however, different geometries may be contemplated for other purposes.

The method of the present invention permits the wires to automatically remain in alignment with the connector pins of an IC as a result of the action of the connecting material in stabilizing and aligning the wires in the wire bundle, once one wire is connected thereto. This leads to reduced effort for attaching each wire using a soldering station since the wires practically hold themselves in place. Although it is anticipated by the inventors that the wires will be brought into electrical contact with the connector pins of the integrated circuit by a soldering process, other attachment methods which provide electrical continuity and stability of the resulting attachment may be used. If desirable, the wires can be separated after attachment to the IC, while a small section of the perforated spacer material might be left intact to add mechanical strength to the solder bond. It is anticipated that the wire bundle of the present invention will be provided having chosen pitches and chosen wire diameters adapted to match the connector spacing of commonly available ICs. The present invention also permits the removal from the wire bundle of only the number of wires needed to match the connector pin count of the IC.

As will be described hereinbelow, the present invention may be used in conjunction with an IC holder that aligns the wire with the IC.

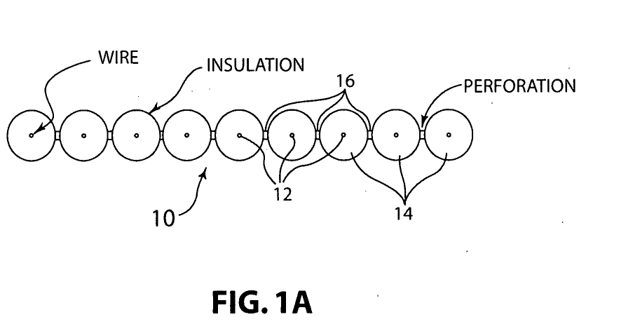

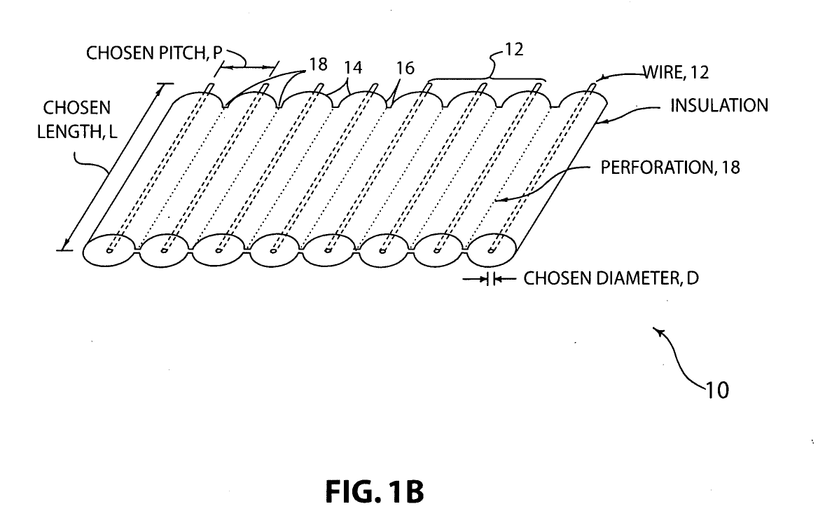

Reference will now be made in detail to the present preferred embodiments of the invention examples of which are illustrated in the accompanying drawings. In what follows, identical callouts will be used for similar or identical structure. Turning now to the figures, FIG. 1a is a schematic representation of an end-on view of wire bundle, 10, of the present invention, while FIG. 1b is a schematic representation of a projection view thereof. Shown in FIGS. 1a and 1b are bundle 10 in its planar embodiment with wires, 12, bearing insulation, 14, part of which is used to form connecting material, 16, which attaches the wires to one another along their lengths, thereby orienting the wires in a parallel configuration with neighboring wires. Perforations, 18, in connecting material 16, shown in FIG. 1b, assist in the separation of the wires without the need for tools.

In the practice of the method of the present invention, wire bundle 10 would be chosen such that the pitch, P, of wires 12 is substantially the same as the spacing of the connector pins for the IC for which wire attachment is to be performed. The appropriate diameter, D, for wires 12 would also be chosen. As an example, the wire diameter could be chosen to match the cross sectional dimension of the IC connector pins. One wire of wire bundle would be placed in electrical contact with a connector pin of the IC, by soldering, as an example of performing this step. As a result, the wire bundle would be stabilized and the other wires could readily be soldered to the matching connector pins on the IC. The attached wires might then be separated from the wire bundle, if desired, or used to connect to the pin connectors of other ICs. The desired length, L, of the connected wires is achieved by cutting the wires from a spool onto which the wire bundle is wound or by cutting the wire bundle to the desired length before the connection procedure is undertaken.

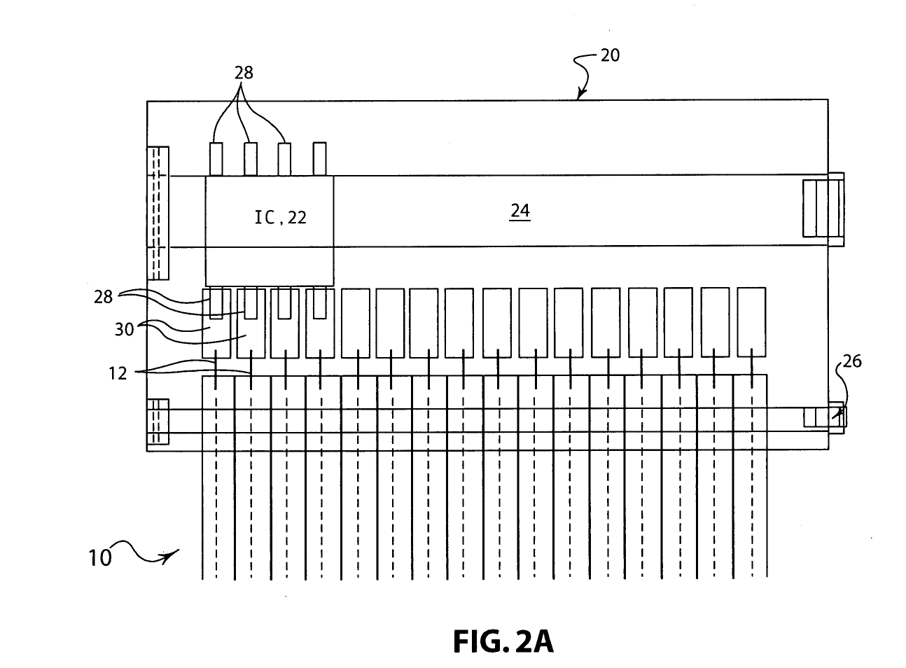

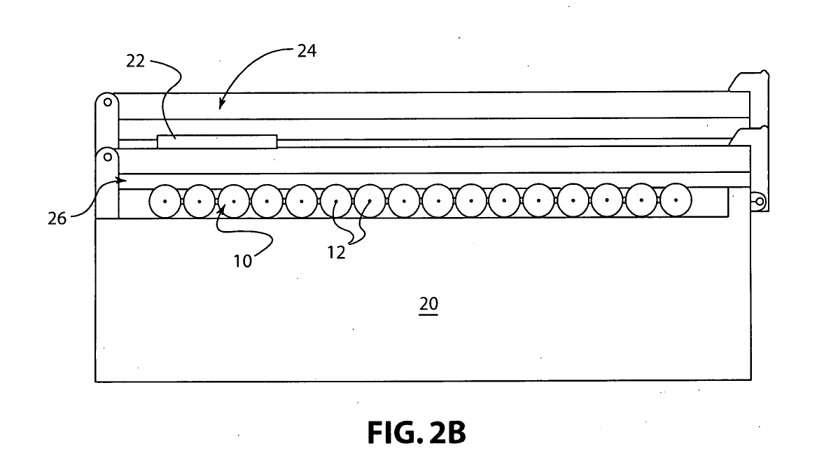

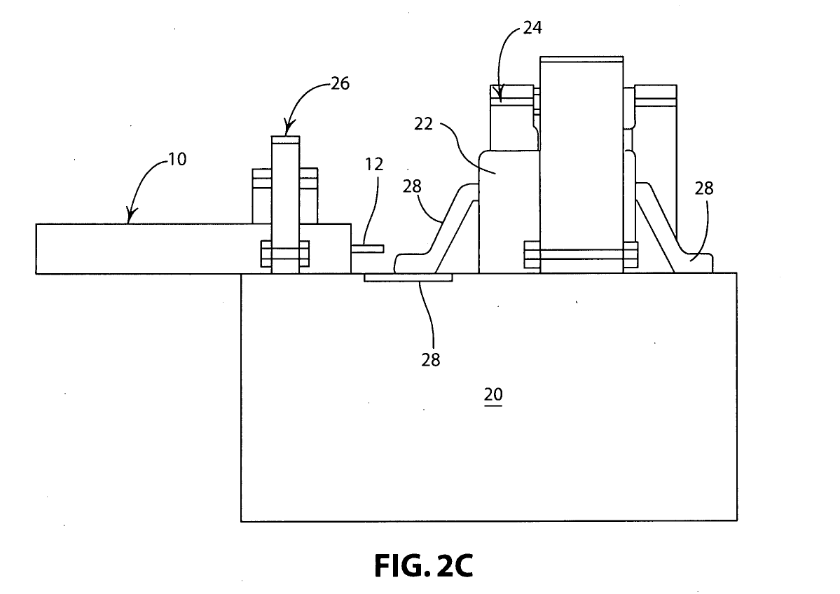

In another example of the use of the wire bundle of the present invention, FIG. 2a is a schematic representation of a top view of an integrated circuit holder, 20, adapted to receive wire bundle 10 and one or more ICs, 22. Clamp, 24, is used to hold IC 22 in place while wire bundle 10 is held in place using wire clamp 26. Pins, 28, of IC 22 are suspended in open cavities, 30, of IC holder 20 which allows wires 12 to be soldered or otherwise electrically connected to IC connector pins 28. The connected IC can then be removed from IC holder 20 with the appropriate number of wires attached to selected pins thereof, by releasing straps 24 and 26.

FIG. 2b is a schematic representation of the front view thereof, and FIG. 2c is a schematic representation of a side view thereof.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A separable wire bundle comprising: a plurality of spaced-apart neighboring wires, each of said wires having a first end and a second end, and forming a bundle having a chosen length wherein at least one of said first end and said second end are exposed, and, wherein said wires are disposed substantially parallel to one another; a material suitable for providing electrical insulation surrounding each wire of said plurality of wires; and grooveless connecting material having a single line of perforation and capable of being torn without the use of tools such that each of said wires in said plurality of wires is joined to at least one neighboring wire along the chosen length and each of said wires can be separated from said at least one neighboring wire without affecting the insulation or electrical continuity thereof along at least a portion of the chosen length.

2. The wire bundle of claim 1, wherein said connecting material is formed from said electrical insulating material surrounding said wires.

3. The wire bundle of claim 2, wherein said insulating material is selected from the group consisting of polytetrafluoroethylene and a polymer comprising tetrafluoroethylene and perfluorovinyl ether.

4. (canceled)

5. The wire bundle of claim 1, wherein said plurality of neighboring wires is substantially planar.

6. The wire bundle of claim 5, wherein each of said wires in said plurality of neighboring wires has a chosen diameter and is separated a chosen distance from neighboring wires in said wire bundle such that said plurality of neighboring wires in said wire bundle substantially match the cross section and pitch of the pins of an integrated circuit to which said wires are to be electrically connected.

7. The wire bundle of claim 6, wherein only the number of wires needed to match the number of connector pins for which connections are to be made to the integrated circuit are separated from said wire bundle.

8. The wire bundle of claim 7, wherein a portion of said connecting material along the chosen length is left unseparated.

9. The wire bundle of claim 1, wherein said wire bundle is adapted to be wound onto a spool such the chosen length of said wire bundle may be achieved by cutting the chosen length from said wound wire bundle.

10. A method for connecting wires to the connector pins of an integrated circuit, the connector pins having a pitch and a cross section, comprising the step of electrically connecting one wire from a plurality of spaced-apart neighboring wires forming a wire bundle having a chosen length and a wire pitch chosen to match the pitch of the connector pins, wherein the wires are disposed substantially parallel to one another, wherein each wire is surrounded by a material suitable for providing electrical insulation therefor, and wherein each wire is joined to at least one neighboring wire along the chosen length by a connecting material which is capable of being tom without the use of tools, such that each wire can be separated from the at least one neighboring wire without affecting the insulation and electrical continuity thereof along at least a portion of the chosen length, to one connector pin of the integrated circuit, thereby stabilizing the wire bundle and aligning other wires in the wire bundle with pins of the integrated circuit.

11. The method of claim 10, further comprising the step of electrically connecting other wires to integrated circuit connector pins with which they are aligned.

12. The method of claim 11, wherein said step of electrically connecting one wire to one pin of said integrated circuit, and wherein said step of electrically connecting other wires to connector pins with which they are aligned are performed by soldering.

13. The method of claim 10, wherein the connecting material is formed from the insulating material surrounding the wires.

14. The method of claim 13, wherein said insulating material is selected from the group consisting of polytetrafluoroethylene and a polymer comprising tetrafluoroethylene and perfluorovinyl ether.

15. The method of claim 13, wherein the separating is perforated for ease of separation thereof.

16. The method of claim 10, wherein the plurality of neighboring insulated wires is substantially planar.

17. The method of claim 16, wherein each of the wires in the plurality of neighboring wires has a chosen diameter and is separated a chosen distance from neighboring wires in the wire bundle such that each wire in the plurality of neighboring wires substantially matches the cross section and pitch of the connector pins of the integrated circuit.

18. The method of claim 17, wherein only the number of wires needed to match the number of connector pins for which connections are to be made to the IC are separated from the wire bundle.

19. The method of claim 18, wherein a portion of the connecting material along the chosen length is left unseparated.

20. The method of claim 10, further comprising the steps of winding the wire bundle on a spool, and cutting the chosen length from the wound wire bundle.
